(19) United States
(12) Patent Application Publication
(10) Pub. No.: US 2005/0194780 A1
(43) Pub. Date: Sep. 8, 2005

(54) High opacity tickets

(76) Inventor: Theodore B. Shockley, Albany, IN (US)

Correspondence Address: BARNES & THORNBURG, 11 SOUTH MERIDIAN, INDIANAPOLIS, IN, 46204, US

(21) Appl. No.: 10/794,387

(22) Filed: Mar. 5, 2004

(51) Int. Cl. B42D 15/00

(52) U.S. Cl. 283/105

(57) ABSTRACT

A ticket is provided for use in prize redemption in family entertainment centers, arcades, location-based entertainment centers, amusement parks, and similar establishments. The ticket may also be used to conduct drawings, raffles and give-a-ways. The ticket may be formed from a sheet of high opacity ticket stock paper having a caliper characteristic in the range of 5 and 7.5 points. The opacity of the paper is above 98%. The substrate may be manufactured and formed into rolls of tickets, or may be manufactured and formed into decks of tickets. Alternatively, the substrate may be manufactured and formed into sheets of tickets or individual tickets.

### BACKGROUND OF THE INVENTION

The present invention relates to tickets, and particularly to tickets used for admission, redemption, point-of-sale, or the like.

### SUMMARY OF THE INVENTION

Tickets are widely used for prize redemption in family entertainment centers, arcades, location-based entertainment centers, amusement parks, and similar establishments. Tickets may also be used to conduct drawings, raffles and give-a-ways.

Organizers of events and companies that dispense tickets typically order tickets by the tens of thousands, and often by the truckload. Beyond the expense of purchasing the actual ticket, ticket-purchasing organizations may expect to pay shipping and storage fees.

The present invention comprises one or more of the following features, elements or combinations thereof. A ticket is illustratively formed from a sheet or strip of a substrate. The substrate is illustratively high opacity ticket stock. The substrate has a caliper characteristic in the range of 5 to 7.5 points. The opacity of the substrate is above 98%. The substrate may be manufactured and formed into rolls of tickets, or may be manufactured and formed into decks of tickets. Alternatively, the substrate may be manufactured and formed into sheets of tickets or individual tickets. A roll of 2000 tickets may have a diameter of less than 6.5 inches. The roll of 2000 tickets may have a weight of less than one pound. The rolls may be packaged in a container that has smaller dimensions than the previously-known shipping container. A container holding four rolls in a two-by-two fashion may have a smaller side dimension than 13.5 inches.

Additional features of the disclosure will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 shows a perspective view of a prior art roll of tickets and the smaller, new roll of tickets made according to the present disclosure;

FIG. 2 shows a front elevation view of an end of a prior art ticket and an end of a ticket made according to the present disclosure;

FIG. 3 shows a perspective view of a portion of a double roll;

FIG. 4 shows a perspective view of a deck of folded tickets;

FIG. 5 shows a top view of a container packed with the prior art rolls of tickets;

FIG. 6 is a top view similar to that of FIG. 5, showing a container packed with rolls of tickets made according to the disclosure; and

FIG. 7 is a top view of the space formed between four rolls, showing the space saved when the rolls are made according to the present disclosure.

### DETAILED DESCRIPTION OF THE DRAWINGS

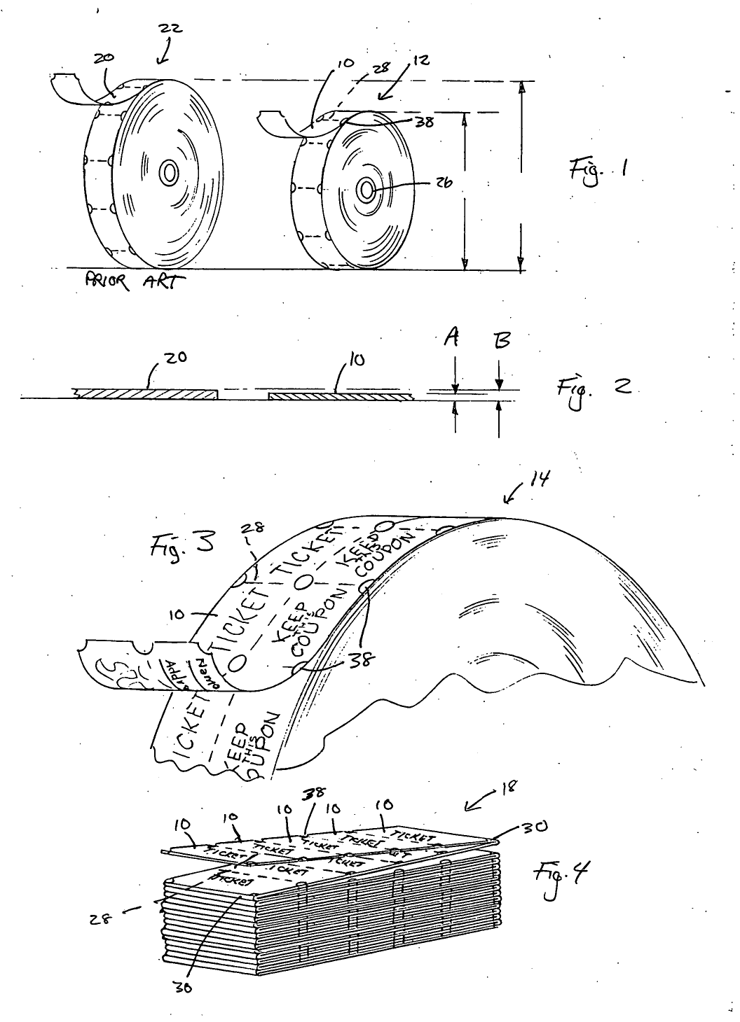

A ticket 10, as can be seen in FIG. 1, may be illustratively used for admission to or for point of purchase applications at any of the following: social events, festivals, carnivals, amusement places, parking lots, academic functions, religious functions, and athletic events, among others. Such a ticket 10 may be available in a wide variety of sizes, shapes, and colors, and may or may not have markings relating to the event. Ticket 10 may be punched, perforated, numbered, or die cut. Ticket 10 can be specifically designed for hand issue, machine issue, mechanical collection, collection and accounting by weight, and/or collection and accounting by audit.

The illustrative tickets 10 may be provided on a roll 12 of 2000 continuous tickets, commonly called “roll tickets” in the industry, as can be seen in FIG. 1. In such an embodiment, tickets 10 are configured to be unrolled from the roll 12 and separated along perforations 28 in increments desired by the dispensing party. Alternatively, tickets 10 may be formed in groups of two or more, and can be dispensed two or more at a time from a “double roll” 14, as can be seen in FIG. 3. A double roll comprises 2000 sets of two tickets, and can be used, for example, in a raffle or lottery scenario. However, it should be understood that other configurations and embodiments are within the scope of the disclosure, and multiple tickets may be rolled adjacent each other. Furthermore, any number of tickets may be provided on a roll, and the tickets could alternatively be grouped in strips or sheets, or may be presented individually or in any other manner known in the industry.

The common ticket 20, which has been known in the art for years, uses a substrate of “common ticket stock” paper having a caliper characteristic of approximately 9.5. Typically, the common ticket stock is comprised of ticket bristol paper, and has an illustrative thickness B, as can be seen in FIG. 2. In contrast, ticket 10 is illustratively printed on a stock of paper that is considered high opacity ticket stock paper. Such high opacity ticket stock having the same length and width dimensions may have a thickness A (as can be seen in FIG. 2). The caliper range may be between 5 and 7.5 points. The illustrative high opacity ticket stock has a caliper of 7. Tickets are illustratively formed to have a width of one inch and a length of two inches, although other dimensions are within the scope of the disclosure.

Additionally, the opacity of a paper may be considered. Although common ticket stock typically has an opacity of greater than 98%, the common ticket stock is much thicker and heavier than the high opacity ticket stock presently disclosed. The illustrative high opacity ticket stock has an opacity of greater than 98%, while having a caliper range of between 5 and 7.5 points. Such high opacity ticket stock can be specially ordered from paper supply companies using the characteristics discussed herein.

It should be understood that while the illustrative substrate is high opacity ticket stock paper, other substrates providing the opacity and caliper characteristics suggested are within the scope of the disclosure. For example, the substrate may be a polymer-based material.

Use of the high opacity ticket stock described provides a ticket 10 having a substantially smaller thickness A than the thickness B of common ticket 20 constructed of common ticket stock, as demonstrated in FIG. 2. The smaller thickness also provides a ticket roll 12 of 2000 tickets that has a substantially smaller diameter than the common ticket roll 22 of 2000 tickets, as can be seen in FIG. 1. Illustratively, a common ticket roll 22 has a diameter of approximately seven (7) inches, and the ticket roll 12 according to specification has a diameter of approximately six (6) inches. The smaller diameter of ticket roll 12 compared to ticket roll 22 allows a box or container 16 of ticket rolls 12 to be shipped and stored in a smaller container 16 than a box or container 24 of ticket rolls 22, as can be seen by comparing the dimensions of containers 16 and 24, shown in FIGS. 5 and 6. The smaller dimension of container 16 allows more containers 16 to be shipped in a given amount of space, i.e. a truckload, and allows more ticket rolls 12 to be stored in a given amount of storage space. Illustratively, container 16 has side dimensions of less than 13.5 inches.

The high opacity of greater than 98% prevents bleeding or burn-through of ticket dispensing sensors. Such sensors are typically optical sensors and misreadings can occur when lower opacity stock paper is used. A typical optical sensor is used for ticket-counting purposes by utilizing the combination of a light beam and sensor positioned on opposite sides of the strip of tickets being dispensed, the light sensor “reading” when the light shines through an aperture or notch 38 formed in the strip of tickets 10. In lower opacity and/or caliper characteristics, such ticket-counting by light sensors may be impaired.

A container 16 shipping ticket rolls 12 made according to the present disclosure is also a more efficient means of shipping ticket rolls because the space 32 between rolls 12 is of smaller dimension than the space 34 between rolls 22. By shipping less air and the same number of tickets, the shipping is more efficient. FIG. 7 illustrates the space saved by using rolls 12 of the present disclosure. The cross-hatched area 36 of FIG. 7 illustrates the shipping space saved when utilizing the presently disclosed rolls 12.

Use of high opacity ticket stock can also provide a ticket 10 having less weight. A common single-ticket roll 22 of 2000 tickets, as shown in FIG. 1, weighs approximately 1.10 pound. A ticket roll 12 of 2000 tickets according to the specification weighs approximately 0.90 pound. Because shipping costs are commonly calculated at least partially based on the weight of the shipment, the lighter weight of the ticket rolls 12 permits a savings on shipping costs to a consumer. Single-ticket rolls 22, such as those shown in FIG. 1, are illustratively shipped in containers 24 having 40 ticket rolls 22. When such single-ticket rolls 22 are manufactured from common ticket stock, the approximately weight of container 24 is forty-seven (47) pounds. When single-ticket rolls 12 are manufactured from the illustrative high opacity ticket stock, the approximate weight of container 16 is thirty-six (36) pounds. Common double-ticket rolls of 2000 tickets weigh approximately 2.35 pounds each, and double rolls 14 according to the disclosure weigh approximately 1.80 pound each.

It is within the scope of the disclosure to provide rolls of any number of tickets. For example, a double roll of 1000 tickets may be provided (not shown). If such a double roll were manufactured from common ticket stock, the diameter would be approximately five (5) inches and the weight would be approximately 1.1 pound. If the double roll were manufactured from the illustrative high opacity ticket stock, the diameter would be approximately 4.375 inches and the weight would be approximately 0.90 pound.

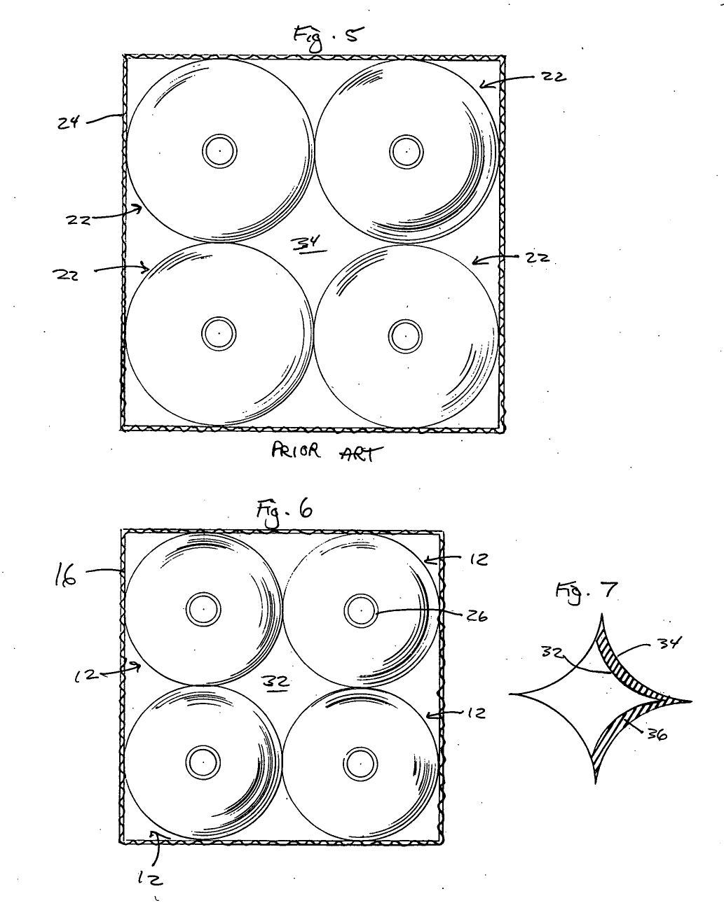

The present disclosure is not limited to tickets on rolls, but can also be applied to sheet tickets, folded decks 18 of tickets (as can be seen in FIG. 4), and any other type of ticket known in the art. One use of folded decks 18 is that of redemption tickets, wherein the tickets are dispensed from a game of skill or chance for redemption of a prize.

A method of manufacturing tickets is also disclosed. The method includes the steps of unwinding a portion of a roll of high opacity ticket stock paper, feeding the unrolled portion through a printer, cutting the paper to form strips of paper, and perforating the strips of paper to form separable tickets therebetween. The method may include rolling tickets 10 on a tube 26 (visible in FIGS. 1 and 6) in a roll 12 of 2000 tickets 10. Alternatively, the method may include forming decks 18 of tickets, typically accordion-folded with five tickets 10 disposed between each fold line 30, as can be seen in FIG. 4. Decks 18 are illustratively packaged in sets of 3000 tickets, although it is within the scope of the disclosure to combine any number of tickets to form a deck.

A method of shipping tickets is also provided by the disclosure. The method includes the steps of providing rolls of 2000 in a container measuring less than 14 inches on each side.

1. A roll of tickets comprising:
a tube, and
a plurality of tickets wrapped around the tube, the plurality of tickets having interconnected ends defining rows of perforations therebetween, the plurality of tickets being formed from a substrate having a caliper characteristic between 5 and 7.5 points and an opacity characteristic of greater than 98%.

2. The roll of tickets of claim 1, wherein the roll comprises 2000 tickets.

3. The roll of tickets of claim 2, wherein the diameter of the roll is less than 6.5 inches.

4. The roll of tickets of claim 1, wherein the substrate is high opacity ticket stock paper.

5. The roll of tickets of claim 1, wherein the caliper characteristic is 7 points.

6. A method of manufacturing a roll of tickets, the method comprising the steps of
unwinding a portion of a roll of paper, the paper having a caliper in the range of 5 and 7.5 points and an opacity of greater than 98%,
feeding the unwound portion of paper through a printer,
cutting the paper to form strips of paper, and
perforating the strips to form separable tickets therebetween.

7. The method of claim 6, further comprising the step of rewinding the tickets in rolls of 2000.

8. The method of claim 6, further comprising the step of folding the tickets to form a deck of tickets.

9. The method of claim 8, wherein the deck comprises 3000 tickets.

10. (canceled)

11. The roll of tickets of claim 1, wherein the opacity is approximately 99%.

12-14. (canceled)

15. The roll of tickets of claim 1, wherein the roll comprises 1000 tickets.

16. The roll of tickets of claim 15, wherein the diameter of the roll is less than 4.5 inches.

17. (canceled)
